(19) United States
(12) Patent Application Publication
(10) Pub. No.: US 2026/0299454 A1
(43) Pub. Date: Oct. 1, 2026

(54) IMAGE FORMING APPARATUS

(71) Applicant: FUJIFILM Business Innovation Corp., Tokyo (JP)

(72) Inventors: Masahiko Kubo, Kanagawa (JP); Yukiaki Nakamura, Kanagawa (JP); Tomoshi Hara, Kanagawa (JP); Yasutomo Ishii, Kanagawa (JP)

(73) Assignee: FUJIFILM Business Innovation Corp., Tokyo (JP)

(21) Appl. No.: 19/315,021

(22) Filed: Aug. 29, 2025

(30) Foreign Application Priority Data
Mar. 26, 2025 (JP) 2025-052650
Mar. 26, 2025 (JP) 2025-052651

(51) Int. Cl. G03G 15/01; G03G 9/09

(52) U.S. Cl. CPC G03G 15/0189; G03G 9/0926

(57) ABSTRACT

An image forming apparatus that forms an image on a recording medium includes a yellow-image forming part that forms an image with a non-fluorescent coloring material in yellow; a magenta-image forming part that forms an image with a non-fluorescent coloring material in magenta; a cyan-image forming part that forms an image with a non-fluorescent coloring material in cyan; a black-image forming part that forms an image with a non-fluorescent coloring material in black; and a fluorescent image forming part that forms an image with a fluorescent coloring material.

### CROSS-REFERENCE TO RELATED APPLICATIONS

This application is based on and claims priority under 35 USC 119 from Japanese Patent Application No. 2025-052650 filed Mar. 26, 2025 and Japanese Patent Application No. 2025-052651 filed Mar. 26, 2025.

### BACKGROUND

### (i) Technical Field

The present disclosure relates to an image forming apparatus.

### (ii) Related Art

U.S. Pat. No. 4,812,899 discloses copying for forming multicolor printing on a print sheet, the multicolor printing being constituted by multiple element regions to which ink is applied, the copying including a process in which an image surface is divided into sub-surfaces having identical sizes and in which each of the sub-surfaces is divided into element regions arranged side by side such that each of the sub-surfaces has a chromatic color component and an achromatic color component.

In addition, U.S. Pat. No. 5,734,800 discloses a printing system including a printing grid that includes a combination of black and five basic ink colors, and three to five of the colors each have a fluorescent portion.

### SUMMARY

An image forming apparatus may perform image formation with coloring materials in yellow, magenta, cyan, black, and the like.

Here, for example, when part of the coloring materials in yellow, magenta, cyan, and black includes a fluorescent coloring material, the color gamut of a formed image can be expanded, compared with that when only non-fluorescent coloring materials are used. In this case, however, due to the included fluorescent coloring material, the light resistance of the formed image decreases.

In this case, when coloring materials to be used are replaced each time, images in which the color gamut is large or images having light resistance can be formed. However, in this case, the workload on an operator who performs this replacement increases.

An aspect of non-limiting embodiments of the present disclosure relate to making it possible to form an image in which the color gamut is large and form an image with high light-resistance by a common image forming apparatus while suppressing the workload on an operator who performs work with respect to the image forming apparatus.

In addition, when a fluorescent toner is used in addition to a non-fluorescent toner in image formation on a recording medium, expansion of the color gamut of a formed image can be addressed.

In addition, when the particle diameter of toner is reduced, granularity of the toner can be increased, and quality improvement in a formed image can be addressed. In the meantime, when the particle diameter of the fluorescent toner is also reduced similarly, the color forming performance thereof decreases and makes it difficult to expand the color gamut.

Another aspect of non-limiting embodiments of the present disclosure relate to addressing both quality improvement and expansion of the color gamut in an image formed on a recording medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus that forms an image on a recording medium, the image forming apparatus including a yellow-image forming part that forms an image with a non-fluorescent coloring material in yellow; a magenta-image forming part that forms an image with a non-fluorescent coloring material in magenta; a cyan-image forming part that forms an image with a non-fluorescent coloring material in cyan; a black-image forming part that forms an image with a non-fluorescent coloring material in black; and a fluorescent image forming part that forms an image with a fluorescent coloring material.

### BRIEF DESCRIPTION OF THE DRAWINGS

An exemplary embodiment of the present disclosure will be described in detail based on the following figures, wherein:

FIG. 1 illustrates an image forming apparatus;

FIG. 2 illustrates a configuration example of hardware of a controller;

FIGS. 3A and 3B illustrate expansion of the color gamut in the exemplary embodiment;

FIG. 4 illustrates colors obtained by a combination of fluorescent pink and non-fluorescent yellow and a combination of fluorescent pink and non-fluorescent cyan;

FIG. 5 illustrates another configuration example of an image forming apparatus;

FIG. 6 illustrates a direct-transfer image forming apparatus; and

FIG. 7 illustrates another configuration example of a direct-transfer image forming apparatus.

### DETAILED DESCRIPTION

Hereinafter, an exemplary embodiment according to the disclosure will be described with reference to the accompanying drawings.

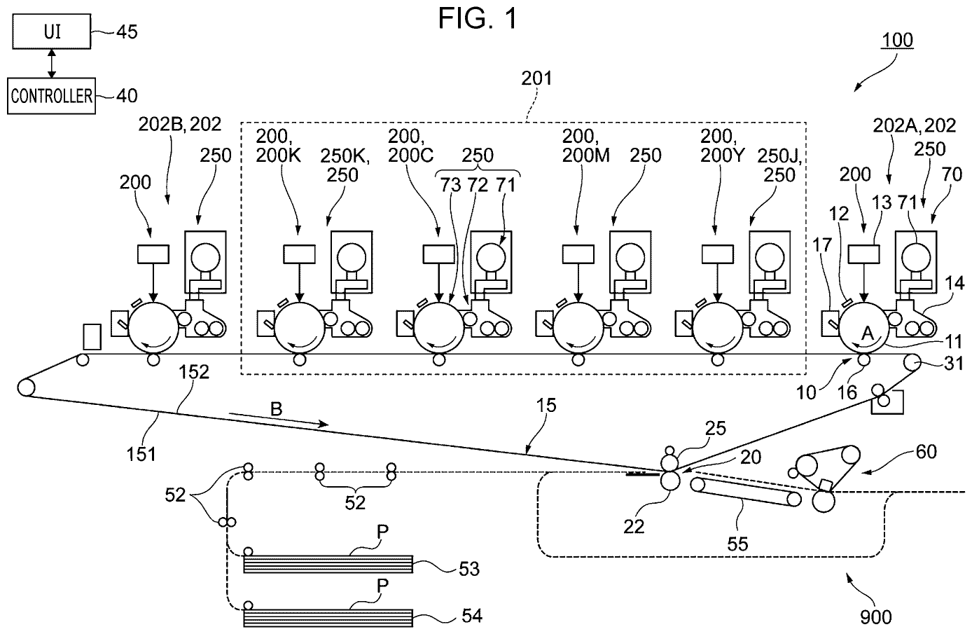

FIG. 1 illustrates an image forming apparatus 100 according to the exemplary embodiment.

The image forming apparatus 100 is an intermediate-transfer image forming apparatus 100, which is called tandem type. The image forming apparatus 100 performs image formation on a sheet P, which is one example of a recording medium.

The image forming apparatus 100 is provided with six image forming parts 200 that each form a toner image that is to be transferred to the sheet P. The image forming apparatus 100 is also provided with an intermediate transfer belt 15 as one example of a transfer target member. Toner images each formed by a corresponding one of the image forming parts 200 are first transferred to the intermediate transfer belt 15.

The toner images each formed by the corresponding image forming part 200 are transferred at a first transfer section 10 to the intermediate transfer belt 15.

Here, a transfer target member to which toner images each formed by a corresponding one of the image forming parts 200 are transferred is the intermediate transfer belt 15.

In the later-described direct transfer system, toner images each formed by a corresponding one of the image forming parts 200 are transferred directly to the sheet P, which is a recording medium. In this case, the sheet P is a transfer target member.

In the exemplary embodiment, toner images each formed by a corresponding one of the image forming parts 200 are first transferred to the intermediate transfer belt 15. Thereafter, the toner images are transferred to the sheet P.

The intermediate transfer belt 15 is a member that circularly moves. In other words, the intermediate transfer belt 15 is a member that moves in a circling manner. An outer circumferential surface 151 of the intermediate transfer belt 15 comes into contact with the sheet P at a second transfer section 20.

Toner images each formed by a corresponding one of the six image forming parts 200 are transferred to the outer circumferential surface 151 of the intermediate transfer belt 15. The toner images transferred on the outer circumferential surface 151 of the intermediate transfer belt 15 are then moved to the second transfer section 20 along with the movement of the intermediate transfer belt 15. The toner images are then transferred to the sheet P at the second transfer section 20. Consequently, an image constituted by the toner images is placed on the sheet P.

At the second transfer section 20, the outer circumferential surface 151 of the intermediate transfer belt 15 comes into contact with the sheet P. The second transfer section 20 is a section where the toner images transferred on the intermediate transfer belt 15 are transferred to the sheet P.

The image forming apparatus 100 is further provided with a fixing device 60 that causes the toner images transferred on the sheet P to be fixed to the sheet P.

The image forming apparatus 100 is also provided with a controller 40 that controls each part in the image forming apparatus 100.

In addition, the image forming apparatus 100 is provided with a user interface (UI) 45 that receives an instruction from a user and that displays information with respect to the user. The UI 45 is constituted by, for example, a touch panel. The UI 45 is a receiving part that receives an instruction from a user and is also a display part that displays information.

Note that the receiving part that receives an instruction from a user and the display part that displays information with respect to the user may be provided individually.

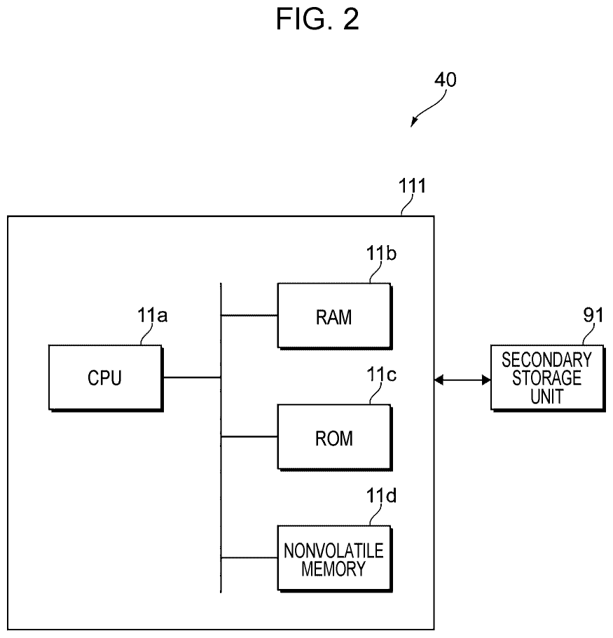

FIG. 2 illustrates a configuration example of hardware of the controller 40. The controller 40 is realized by a computer.

The controller 40 includes an arithmetic processing unit 111 that executes digital arithmetic processing in accordance with a program, and a secondary storage unit 91 that stores information.

The secondary storage unit 91 is realized by an existing information storage device, for example, a hard disk drive (HDD), a semiconductor memory, a magnetic tape, or the like.

The arithmetic processing unit 111 is provided with a CPU 11a as one example of a processor.

The arithmetic processing unit 111 is also provided with a RAM 11b that is used as a working memory or the like for the CPU 11a. In addition, the arithmetic processing unit 111 is provided with a ROM 11c in which a program and the like to be executed by the CPU 11a are stored.

Additionally, the arithmetic processing unit 111 is provided with a nonvolatile memory 11d capable of holding data even when power supply is interrupted.

The nonvolatile memory 11d is constituted by, for example, a battery-backed-up SRAM, a flash memory, or the like. The secondary storage unit 91 stores various types of information on, for example, a program to be executed by the arithmetic processing unit 111.

In the exemplary embodiment, the CPU 11a of the arithmetic processing unit 111 reads programs stored in the ROM 11c or the secondary storage unit 91. The CPU 11a executes the programs stored in the ROM 11c or the secondary storage unit 91. Consequently, various types of processing to be performed in the image forming apparatus 100 are executed. The various types of processing to be performed in the image forming apparatus 100 are executed by the CPU 11a.

Programs to be executed by the CPU 11a can be provided to the image forming apparatus 100 through a storage medium.

One example of the storage medium is a magnetic storage medium such as a magnetic tape or a magnetic disk. In addition, another example of the storage medium is an optical storage medium such as an optical disc.

Additionally, a magneto-optical storage medium is also another example of the storage medium. In addition, a semiconductor memory or the like is also another example of the storage medium.

The programs to be executed by the CPU 11a also may be provided using a communication method such as the Internet to the image forming apparatus 100.

With reference to FIG. 1, the image forming apparatus 100 will be described further.

Each of the image forming parts 200 is provided with a developing device 14. Each of the image forming parts 200 is also provided with a developer supplying device 70 that supplies developer to the developing device 14.

The developing device 14 causes an electrostatic latent image on a photoconductor drum 11 to be a visible image with toner.

The developer supplying device 70 is provided with a toner cartridge 71. The developer supplying device 70 supplies developer from the toner cartridge 71 to the developing device 14 by transporting the developer to the developing device 14.

The developer is constituted by a carrier and toner. The developer supplying device 70 supplies the carrier and the toner to the developing device 14. The carrier in the exemplary embodiment is a dry-type carrier, and the toner is a powdery toner.

In each of the image forming parts 200, the photoconductor drum 11 as one example of an image carrier rotates in the arrow A direction.

In addition, each of the image forming parts 200 is provided with a charger 12 that electrostatically charges the photoconductor drum 11, and an exposure device 13 that forms an electrostatic latent image on the photoconductor drum 11.

The exposure device 13 includes a light source such as an LED and irradiates the photoconductor drum 11 with light. Consequently, an electrostatic latent image is formed on a surface of the photoconductor drum 11 that has been electrostatically charged by the charger 12.

Thereafter, the developing device 14 supplies the toner to the surface of the photoconductor drum 11. Consequently, the electrostatic latent image on the photoconductor drum 11 is caused to be a visible image with the toner. A toner image is thereby formed on the surface of the photoconductor drum 11.

In the exemplary embodiment, a toner image, which is an image to be transferred to the sheet P, is formed using developer on the photoconductor drum 11 as one example of an image carrier.

In each of the image forming parts 200, a toner image to be transferred to the sheet P is formed using powdery developer on the photoconductor drum 11. Consequently, the toner image is in a state of being temporarily held by the photoconductor drum 11.

In the exemplary embodiment, the toner image temporarily held on the photoconductor drum 11 is then transferred to the outer circumferential surface 151 of the intermediate transfer belt 15 at the first transfer section 10 where a first transfer roller 16 is provided.

In the exemplary embodiment, the toner remaining on the photoconductor drum 11 is removed by a drum cleaner 17 after transfer of toner images to the intermediate transfer belt 15.

The intermediate transfer belt 15 is caused to circularly move in the arrow B direction illustrated in FIG. 1 by a driving roller 31 that is driven by a motor (not illustrated). The motor and the driving roller 31 function as a moving member that moves the intermediate transfer belt 15.

The toner images each formed on a corresponding one of the photoconductor drums 11 are electrostatically attracted, at the first transfer section 10 corresponding thereto, to the intermediate transfer belt 15. Consequently, toner images in which toner images in different colors are superimposed are formed on the intermediate transfer belt 15.

The second transfer section 20 is provided with a second transfer roller 22 disposed on the side of the outer circumferential surface 151 of the intermediate transfer belt 15, and a backup roller 25 disposed on the side of an inner circumferential surface 152 of the intermediate transfer belt 15.

In the exemplary embodiment, the toner images transferred on the intermediate transfer belt 15 are transferred at the second transfer section 20 to the sheet P transported to the second transfer section 20.

After being transferred to the intermediate transfer belt 15, the toner images each formed by a corresponding one of the image forming parts 200 are moved to the second transfer section 20 by the movement of the intermediate transfer belt 15.

In addition, at this time, the sheet P from a first sheet storage section 53 or a second sheet storage section 54 is transported to the second transfer section 20 by a transport roller 52.

The toner images on the intermediate transfer belt 15 are then electrostatically transferred at the second transfer section 20 collectively onto the sheet P.

Thereafter, the sheet P on which the toner images are transferred is separated from the intermediate transfer belt 15 and transported to a transport belt 55. The transport belt 55 transports the sheet P to the fixing device 60.

The sheet P transported to the fixing device 60 is heated and pressurized at the fixing device 60. Consequently, the toner images on the sheet P are fixed to the sheet P. The sheet P is then discharged from the image forming apparatus 100.

A reversing mechanism 900 that reverses the sheet P is further provided in the exemplary embodiment.

The reversing mechanism 900 reverses the front and back of the sheet P having one surface on which toner images are transferred at the second transfer section 20, and supplies the sheet P again to the second transfer section 20. Consequently, formation of toner images on both surfaces of the sheet P is performed in the exemplary embodiment.

### Image Forming Part

The image forming part 200 will be described further.

In the exemplary embodiment, six image forming parts 200 are provided.

The six image forming parts 200 form toner images with toners of types different from each other. The six image forming parts 200 each form a toner image, which is to be transferred to the intermediate transfer belt 15, with toner as one example of a coloring material.

In the exemplary embodiment, among the six image forming parts 200, the four image forming parts 200 indicated by the sign 201 each form a toner image with a toner in a basic color that is yellow, magenta, cyan, or black. In the exemplary embodiment, toners in basic colors are toners in the four colors that are yellow, magenta, cyan, and black.

In the exemplary embodiment, a yellow image forming part 200Y that forms a toner image with a non-fluorescent toner in yellow is provided as an image forming part 200 constituting the four image forming parts 200 indicated by the sign 201.

In addition, a magenta image forming part 200M that forms a toner image with a non-fluorescent toner in magenta and a cyan image forming part 200C that forms a toner image with a non-fluorescent toner in cyan are provided as image forming parts 200 constituting the four image forming parts 200.

In addition, a black image forming part 200K that forms a toner image with a non-fluorescent toner in black is provided as an image forming part 200 constituting the four image forming parts 200.

Each of the yellow image forming part 200Y, the magenta image forming part 200M, the cyan image forming part 200C, and the black image forming part 200K performs formation of a toner image in a form that realizes color reproduction in compliance with ISO12647-2, which is an international standard relating to offset printing.

Specific examples of color reproduction in compliance with ISO12647-2 are, for example, JapanColor, Fogra, and SWOP.

When formation of a toner image in a form that realizes color reproduction in compliance with ISO12647-2 is performed, color reproduction equivalent to that in normal offset printing may be realized, and a printed material with high light-resistance may be obtained.

In the present specification, the aforementioned four image forming parts 200 indicated by the sign 201 may be hereinafter referred to as “basic-color image forming part 201”.

The basic-color image forming part 201 as one example of a non-fluorescent image forming part forms a toner image, which is to be transferred to the intermediate transfer belt 15, with a toner in at least one color included in the basic colors consisting of the four colors that are yellow, magenta, cyan, and black.

In the basic-color image forming part 201, the image forming parts 200 to be used are switched in accordance with an image to be formed on the sheet P. The basic-color image forming part 201 forms a toner image with a toner in at least one color included in the four colors.

For example, when an image to be formed on the sheet P is a monochrome image, a black toner is used to form a toner image in the basic-color image forming part 201.

In addition, when an image to be formed on the sheet P is a full-color image, toners in the four colors are used to form toner images in the basic-color image forming part 201.

Further, among the six image forming parts 200, the remaining two image forming parts 200 are other-color image forming parts 202 in the exemplary embodiment.

The other-color image forming parts 202 each form an image with a fluorescent toner. The other-color image forming parts 202 are each capable of forming a toner image with a fluorescent toner.

There are provided multiple other-color image forming parts 202.

In the exemplary embodiment, an upstream other-color image forming part 202A and a downstream other-color image forming part 202B are provided as the other-color image forming parts 202.

The upstream other-color image forming part 202A is located upstream of the downstream other-color image forming part 202B in a moving direction of the intermediate transfer belt 15.

In addition, the upstream other-color image forming part 202A is located upstream of the basic-color image forming part 201 in the moving direction of the intermediate transfer belt 15.

In addition, the downstream other-color image forming part 202B is located downstream of the basic-color image forming part 201 in the moving direction of the intermediate transfer belt 15.

Each of the upstream other-color image forming part 202A and the downstream other-color image forming part 202B forms a toner image with a fluorescent toner.

One other-color image forming part 202 that is one of the upstream other-color image forming part 202A and the downstream other-color image forming part 202B forms a toner image with a fluorescent toner in one color. In addition, the other other-color image forming part 202 forms a toner image with a fluorescent toner in another color that differs from the one color.

In addition, each of the upstream other-color image forming part 202A and the downstream other-color image forming part 202B forms a toner image with a fluorescent toner in a color other than yellow, magenta, cyan, and black.

Specifically, the upstream other-color image forming part 202A forms a pink toner image with a fluorescent pink toner. In addition, the downstream other-color image forming part 202B forms a green toner image with a fluorescent green toner.

The upstream other-color image forming part 202A is capable of performing toner-image formation with the fluorescent pink toner. In addition, the downstream other-color image forming part 202B is capable of performing toner-image formation with the fluorescent green toner.

With the upstream other-color image forming part 202A and the downstream other-color image forming part 202B, the color gamut of an image formed on the sheet P may be expanded in the exemplary embodiment, compared with a configuration in which only the basic-color image forming part 201 is provided.

Here, the fluorescent green toner is not particularly limited as long as the fluorescent green toner is a toner that exhibits fluorescence. In the exemplary embodiment, the hue angle of the fluorescent green toner is 125 degrees or more and 165 degrees or less.

The fluorescent pink toner is also not particularly limited as long as the fluorescent pink toner is a toner that exhibits fluorescence. In the exemplary embodiment, the hue angle of the fluorescent pink toner is −25 degrees or more and 15 degrees or less.

The fluorescent toners each contain a fluorescent colorant and a binder resin and include, as necessary, toner particles containing a mold release agent and other additives.

Here, the fluorescent colorant is a colorant that is caused to emit light by light energy from the outside. This colorant may be dye and may be pigment. The fluorescent toners in the exemplary embodiment are each caused to emit light by light energy from the outside.

The fluorescent toners in the exemplary embodiment are each caused to exhibit a color by reflected light and light emission.

In contrast, non-fluorescent toners contain no fluorescent colorant, and the non-fluorescent toners are not caused to emit light by light energy from the outside. The non-fluorescent toners are each caused to exhibit a color by reflected light only.

Here, the upstream other-color image forming part 202A can be regarded as an upstream fluorescent-image forming part that forms a toner image, which is to be transferred to the intermediate transfer belt 15, with a fluorescent toner in another color other than the aforementioned basic colors.

In addition, the downstream other-color image forming part 202B can be regarded as a downstream fluorescent-image forming part that forms a toner image, which is to be transferred to the intermediate transfer belt 15, with a fluorescent toner in another color other than the aforementioned basic colors.

Since the upstream other-color image forming part 202A forms a fluorescent toner image, the upstream other-color image forming part 202A can be, in other words, an upstream fluorescent-image forming part. In addition, since the downstream other-color image forming part 202B also forms a fluorescent toner image, the downstream other-color image forming part 202B can be, in other words, a downstream fluorescent-image forming part.

Note that the upstream other-color image forming part 202A is not limited to that described above and may form a toner image with a fluorescent toner in green. In addition, the downstream other-color image forming part 202B may form a toner image with a fluorescent toner in pink.

In addition, each of the upstream other-color image forming part 202A and the downstream other-color image forming part 202B may form a toner image with a fluorescent toner in another color, such as a fluorescent toner in yellow or a fluorescent toner in orange. When a fluorescent coloring material is used, the color gamut of a highly saturated bright color may be expanded.

The other-color image forming parts 202 are each capable of performing toner-image formation with at least one fluorescent toner among a fluorescent toner in pink, a fluorescent toner in green, a fluorescent toner in yellow, and a fluorescent toner in orange.

In the exemplary embodiment, the other-color image forming parts 202 are each capable of performing toner-image formation with a fluorescent toner.

In contrast, each of the yellow image forming part 200Y, the magenta image forming part 200M, the cyan image forming part 200C, and the black image forming part 200K does not use fluorescent toners.

Each of the yellow image forming part 200Y, the magenta image forming part 200M, the cyan image forming part 200C, and the black image forming part 200K uses a non-fluorescent toner to perform toner-image formation.

In the exemplary embodiment, it may be possible to perform image formation in the following four image forming modes including the first image forming mode to the fourth image forming mode.

First image forming mode: a mode in which toner images are formed by operating the basic-color image forming part 201 without operating the upstream other-color image forming part 202A and the downstream other-color image forming part 202B.

Second image forming mode: a mode in which toner images are formed by operating the basic-color image forming part 201 and the downstream other-color image forming part 202B without operating the upstream other-color image forming part 202A.

Third image forming mode: a mode in which toner images are formed by operating the basic-color image forming part 201 and the upstream other-color image forming part 202A without operating the downstream other-color image forming part 202B.

Fourth image forming mode: a mode in which toner images are formed by operating the upstream other-color image forming part 202A, the downstream other-color image forming part 202B, and the basic-color image forming part 201.

Note that “operating the basic-color image forming part 201” includes a mode in which only part of the image forming parts 200 is operated, such as a mode in which, among the image forming parts 200 for the aforementioned four colors indicated by the sign 201, one image forming part 200 is operated.

In the exemplary embodiment, an image forming mode desired by a user is selected from the aforementioned four image forming modes by the user through the UI 45.

On the basis of the image forming mode selected by the user, the CPU 11a specifies the image forming parts 200 to be operated and operates the specified image forming parts 200.

In this case, in the image forming apparatus 100, each part operates in the image forming mode selected by the user from the aforementioned four image forming modes.

In the exemplary embodiment, it may be possible to perform image formation on the sheet P without using the upstream other-color image forming part 202A and the downstream other-color image forming part 202B.

An image formed on the sheet P without using the upstream other-color image forming part 202A and the downstream other-color image forming part 202B includes no fluorescent toner.

Here, the color gamut is narrowed in color reproduction using widely used CMYK coloring materials. In this case, reproduction of bright colors and vivid colors that can be expressed with RGB becomes difficult. In other words, reproduction of bright colors and vivid colors that can be expressed on a monitor or the like becomes difficult.

In addition, in color reproduction using CMYK coloring materials, there is an issue that reproduction of the color of special color ink is impossible.

To address these issues, there is known Hi-Fi color printing (U.S. Pat. No. 4,812,899) using coloring materials in seven colors including, in addition to CMYK coloring materials, non-fluorescent OGV coloring materials corresponding to RGB. The OGV coloring materials are orange, green, and violet coloring materials.

In the Hi-Fi color printing, the color gamut in the RGB directions can be expanded. In this case, reproduction of special colors can be improved.

However, in Hi-Fi color printing, reproduction of bright colors and vivid colors is difficult, and reproduction of RGB is difficult. In addition, an image forming apparatus that performs Hi-Fi color printing is a 7-color apparatus, leading to a size increase of the apparatus or leading to a cost increase.

In addition, hexachrome printing (U.S. Pat. No. 5,734,800) is known.

The hexachrome printing uses a fluorescent coloring material in yellow, a fluorescent coloring material in orange, a fluorescent coloring material in magenta, a non-fluorescent coloring material in cyan, a non-fluorescent coloring material in black, and a non-fluorescent coloring material in green.

Coloring materials in six colors are used in the hexachrome printing. In this case, the image forming apparatus is a 6-color apparatus, and it may be possible to address a size reduction of the apparatus, compared with the image forming apparatus that performs Hi-Fi color printing.

Since hexachrome printing uses a fluorescent coloring material in the red direction, it may be possible in color reproduction in the red direction to express RGB.

However, the color gamut is narrow in other directions in which no fluorescent coloring material is used. In hexachrome printing, there is still an issue that reproduction of RGB and the color of special color ink is difficult.

In hexachrome printing, there is also an issue that the workload of an operator increases.

To obtain an image having sufficient light resistance by using only coloring materials in CMYK, which are basic colors, in hexachrome printing, it is required to switch the fluorescent coloring material in yellow and the fluorescent coloring material in magenta to a non-fluorescent coloring material in yellow and a non-fluorescent coloring material in magenta.

In this case, the workload of an operator increases.

Images containing a fluorescent coloring material tend to have insufficient light resistance. To obtain an image having sufficient light resistance, it is required to switch the fluorescent coloring material in yellow and the fluorescent coloring material in magenta to the non-fluorescent coloring material in yellow and the non-fluorescent coloring material in magenta. In this case, the workload of an operator increases.

In contrast, the image forming apparatus 100 in the exemplary embodiment is configured such that non-fluorescent toners are used for the four colors of CMYK.

In this case, by simply setting such that the fluorescent toner in pink and the fluorescent toner in green are not used, it may be possible for the image forming apparatus 100 in the exemplary embodiment to form an image having light resistance and in which only coloring materials in CMYK, which are basic colors, are used

The image forming apparatus 100 in the exemplary embodiment is capable of forming an image having light resistance without switching of the fluorescent coloring material in yellow and the fluorescent coloring material in magenta to the non-fluorescent coloring material in yellow and the non-fluorescent coloring material in magenta. In this case, it may be possible to form an image having light resistance without causing an increase in the workload of an operator.

Further, it may become possible in the exemplary embodiment to express RGB and the color of special color ink, which are difficult to be expressed in the aforementioned system in the related art, in printing by using the fluorescent pink toner and the fluorescent green toner. Further, it may become possible in the exemplary embodiment to realize this expression in a 6-color apparatus.

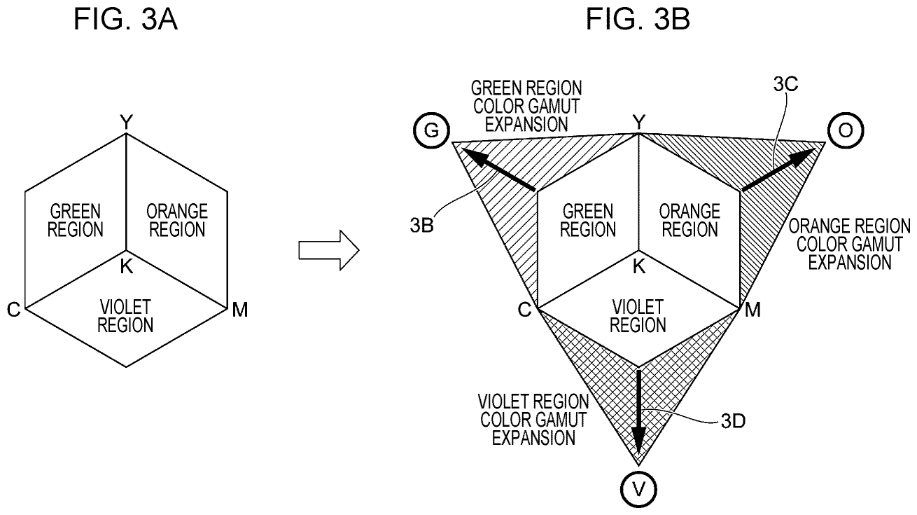

FIGS. 3A and 3B illustrate expansion of the color gamut in the exemplary embodiment.

FIG. 3A illustrates the color gamut in the related art. The color gamut illustrated in FIG. 3A is smaller than the color gamut illustrated in FIG. 3B.

In the exemplary embodiment, the color gamut of the green region may be expanded as illustrated by the arrow 3B in FIG. 3B by fluorescent green. Consequently, it may become possible to express RGB in color reproduction in the green direction.

In addition, in the exemplary embodiment, the color gamut of the orange region and the violet region may be expanded as illustrated by the arrows 3C and 3D in FIG. 3B by the fluorescent toner in pink.

Consequently, it may become possible in the exemplary embodiment to express RGB also in color reproduction in the orange direction and color reproduction in the violet direction.

In the exemplary embodiment, as indicated by the arrow 3C, the color gamut of orange may be expanded by a combination, indicated by “Y” in FIG. 3B, of the non-fluorescent toner in yellow and the fluorescent toner in pink.

In addition, in the exemplary embodiment, as indicated by the arrow 3D, the color gamut of violet may be expanded by a combination, indicated by “C” in FIG. 3B, of the non-fluorescent toner in cyan and the fluorescent toner in pink.

Consequently, it may become possible to express RGB also in color reproduction in the orange direction and color reproduction in the violet direction.

As a result, it may become possible in the exemplary embodiment to express RGB in color reproduction in all the three directions of RGB. Further, in the exemplary embodiment, it may be possible in this color reproduction in all the three directions of RGB to perform this color reproduction with, instead of three colors, two colors of fluorescent green and fluorescent pink.

Even when fluorescent green and fluorescent pink are added to the four colors, which are basic colors, the number of colors is six, and it may be possible in the exemplary embodiment to address expansion of the color gamut in the three directions of RGB with a 6-color apparatus.

Further, a fluorescent toner is used in expansion of the color gamut in each of the three directions of RGB. In this case, bright colors and vivid colors that exert high color forming performance and that can be expressed on a monitor or the like may be reproduced.

Further, as described above, it may be possible in formation of an image having light resistance in the exemplary embodiment to form the image having light resistance without causing an increase in the workload of an operator.

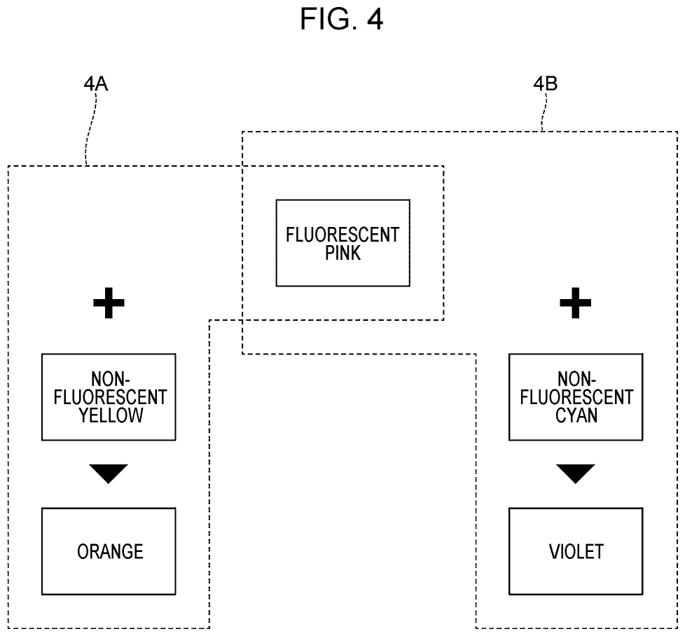

FIG. 4 illustrates colors obtained by a combination of fluorescent pink and non-fluorescent yellow and a combination of fluorescent pink and non-fluorescent cyan.

As indicated by the sign 4A, when fluorescent pink and non-fluorescent yellow are combined together, the colors thereof become orange in the exemplary embodiment.

In addition, as indicated by the sign 4B, when fluorescent pink and non-fluorescent cyan are combined together, the colors thereof become violet in the exemplary embodiment.

Further, as described above, fluorescent green is also prepared in the exemplary embodiment.

In this case, in the exemplary embodiment, fluorescent coloring materials for each of the three colors of RGB are provided substantially. In this case, it may be possible in the three directions of RGB to address expansion of the color gamut in a state in which color forming performance is high.

### Replacement of Unit

Description will be continued with re-reference to FIG. 1.

In the exemplary embodiment, it may be possible in each of the six image forming parts 200 to detach an image forming unit 250 constituting the image forming part 200. Further, it may be possible to mount another image forming unit 250, which differs from the image forming unit 250 before being detached, on the image forming part 200 after detachment of the image forming unit 250.

In the exemplary embodiment, the image forming units 250, which are used for image formation, are each mounted as illustrated in FIG. 1 on a corresponding one of the six image forming parts 200.

The image forming units 250 are provided to be aligned in the moving direction of the intermediate transfer belt 15.

In the exemplary embodiment, by replacing the image forming unit 250 with another image forming unit 250, the image forming part 200 after the replacement is enabled to form a toner image that differs from a toner image formed before the replacement.

In the exemplary embodiment, each of the image forming units 250 is constituted by multiple members including the toner cartridge 71, a developing unit 72, a drum unit 73, and the like.

In the exemplary embodiment, part of members constituting the image forming unit 250 or all of the members are replaced in replacement of the image forming unit 250. In replacement of the image forming unit 250, at least the toner cartridge 71 is replaced.

Replacement of the image forming unit 250 is not limited to replacement of all of the members constituting the image forming unit 250 and includes a form in which part of the members is replaced.

When replacement of the image forming unit 250 is performed, a toner image formed by the image forming part 200 is changed to a different image.

In the exemplary embodiment, replacing the image forming unit 250 enables toner-image formation with, for example, a toner containing metal powder, a white toner, a toner having adhesiveness, or a transparent toner.

The toner having adhesiveness is a toner capable of applying, when pressurized or heated, adhesiveness to a toner image formed with this toner.

Hereinafter, in the present specification, the toner containing metal powder, the white toner, the toner having adhesiveness, the transparent toner, and the like may be referred to as “functional toner”.

When this functional toner is to be used, the image forming unit 250 is replaced in, for example, the upstream other-color image forming part 202A or the downstream other-color image forming part 202B.

In the exemplary embodiment, replacing the image forming unit 250 enables formation of a toner image having a function that differs from a function of a toner image formed before the image forming unit 250 is replaced.

Here, the toner containing metal powder, the white toner, the toner having adhesiveness, and the transparent toner are each a non-fluorescent toner.

In the exemplary embodiment, each of the upstream other-color image forming part 202A and the downstream other-color image forming part 202B is also capable of performing toner-image formation with a non-fluorescent toner.

A case where replacement of the image forming unit 250 is performed in the upstream other-color image forming part 202A and the downstream other-color image forming part 202B so that functional toners are used is considered. In this case, each of the upstream other-color image forming part 202A and the downstream other-color image forming part 202B is enabled to form a toner image with a non-fluorescent toner.

When formation of a toner image with a functional toner is performed by the upstream other-color image forming part 202A or the downstream other-color image forming part 202B, a toner image formed with the functional toner is located close to the surface layer of an image formed on the sheet P or close to the sheet P.

In the exemplary embodiment, by replacing the image forming unit 250, formation of an image having high light-reflectivity or an image having adhesiveness onto the sheet P is enabled.

In the exemplary embodiment, when the toner containing metal powder is used, formation of an image having high light-reflectivity onto the sheet P is enabled.

In addition, in the exemplary embodiment, when the toner having adhesiveness is used, formation of an image having adhesiveness onto the sheet P is enabled.

In addition, in the exemplary embodiment, replacing the image forming unit 250 enables formation of a toner image having a color that differs from the color of a toner image formed before the replacement.

In the exemplary embodiment, replacing the image forming units 250 makes it possible to form, as toner images constituting an image formed on the sheet P, a toner image having metallic gloss, a white toner image, and a transparent toner image.

A toner image formed with the aforementioned toner containing metal powder is a toner image having metallic gloss. In addition, a toner image formed with the white toner is a white toner image. In addition, a toner image formed with the aforementioned transparent toner is a transparent toner image.

The color of the toner image having metallic gloss, the color of the white toner image, and the color of the transparent toner image differ from the color of a toner image formed with the aforementioned fluorescent pink toner.

In addition, the color of the toner image having metallic gloss, the color of the white toner image, and the color of the transparent toner image differ from the color of a toner image formed with the aforementioned fluorescent green toner.

In the exemplary embodiment, replacing the image forming unit 250 enables formation of a toner image having a color different from the color of a toner image formed before replacement of the image forming unit 250.

In the exemplary embodiment, the upstream other-color image forming part 202A and the downstream other-color image forming part 202B are provided.

Consequently, it may be possible to form a layer of a functional toner at both a position closer than a layer of basic-color toner images, which are toner images formed with toners in the aforementioned four colors, to the sheet P and a position closer than the layer of the basic-color toner images to the surface layer.

In the exemplary embodiment, an image is eventually formed on the sheet P. This image includes a surface-layer-side portion, which is a portion located close to the surface layer thereof, and a sheet-side portion, which is a portion located close to the sheet P.

The upstream other-color image forming part 202A and the downstream other-color image forming part 202B enable formation of a layer of a functional toner at both the surface-layer-side portion and the sheet-side portion.

Here, it is assumed that the toner containing metal powder is used. Further, it is assumed that, in the configuration, the downstream other-color image forming part 202B is not provided and only the upstream other-color image forming part 202A is provided.

In this case, there is a likelihood that basic-color toner images are covered by a layer of a toner image having metallic gloss.

In this case, the layer of the toner image having metallic gloss is located at the surface-layer-side portion. In this case, the basic-color toner images are covered by this layer of the toner image having metallic gloss.

In contrast, in the exemplary embodiment, the downstream other-color image forming part 202B is provided.

In this case, it may be possible to form a layer of a toner image having metallic gloss at the sheet-side portion.

When the toner having metallic gloss is used in the downstream other-color image forming part 202B, the layer of the toner image having metallic gloss is formed at the sheet-side portion.

In this case, a situation in which the basic-color toner images are covered is avoided. In addition, in this case, it may be possible to apply brilliance to an image formed on the sheet P.

In addition, it is assumed that the white toner is used. Further, it is assumed that, in the configuration, the downstream other-color image forming part 202B is not provided and only the upstream other-color image forming part 202A is provided.

In this case, a layer of this white toner tends to be located at the surface-layer-side portion. In this case, the layer of the white toner does not easily function as a base.

The white toner is often used to form a base. In the configuration in which only the upstream other-color image forming part 202A is provided, it is not possible for the layer of the white toner to function as a base.

In contrast, in the exemplary embodiment, the downstream other-color image forming part 202B is provided. Consequently, it becomes easy to cause the layer of the white toner to be located at the sheet-side portion.

When the white toner is used in the downstream other-color image forming part 202B, the layer of the white toner is located at the sheet-side portion.

In this case, it may be possible for the layer of the white toner to function as a base.

In addition, it is assumed that the toner having adhesiveness is used. Further, it is assumed that, in the configuration, the upstream other-color image forming part 202A is not provided and only the downstream other-color image forming part 202B is provided.

In this case, a layer of the toner having adhesiveness tends to be located at the sheet-side portion. In this case, the layer of the toner having adhesiveness does not easily function as a layer for adhesion.

The layer of the toner having adhesiveness functions as, for example, an adhesive to be used to bond the sheet P that is folded.

In this case, when the layer of the toner having adhesiveness tends to be located at the sheet-side portion, the layer of the toner having adhesiveness does not easily function as a layer for adhesion.

In contrast, in the exemplary embodiment, the upstream other-color image forming part 202A is provided. In this case, it may be possible to form the layer of the toner having adhesiveness at the surface-layer-side portion.

In this case, by using the toner having adhesiveness in the upstream other-color image forming part 202A, it may be possible to form the layer of the toner having adhesiveness at the surface-layer-side portion.

In this case, the layer of the toner having adhesiveness easily functions as a layer for adhesion.

In addition, it is assumed that the transparent toner is used. Further, it is assumed that, in the configuration, the upstream other-color image forming part 202A is not provided and only the downstream other-color image forming part 202B is provided.

In this case, a layer of the transparent toner tends not to be located at the surface-layer-side portion and tends to be located at the sheet-side portion. In this case, the layer of the transparent toner does not easily function as a layer for improving efficiency in transfer of the basic-color toner image.

In contrast, when the upstream other-color image forming part 202A is provided as in the exemplary embodiment, it may be possible to form the layer of the transparent toner at the surface-layer-side portion.

In this case, the layer of the transparent toner easily functions as a layer for improving efficiency in transfer of the basic-color toner image.

When the layer of the transparent toner is provided at the surface-layer-side portion, the basic-color toner images may be less likely to remain on the outer circumferential surface 151 of the intermediate transfer belt 15.

When the layer of the transparent toner is provided at the surface-layer-side portion, the basic-color toner images may be less likely to remain on the outer circumferential surface 151 after transfer of the toner images from the outer circumferential surface 151 to the sheet P.

In this case, efficiency in transfer of the basic-color toner images to the sheet P may be improved.

When the layer of the transparent toner is provided at the surface-layer-side portion, the layer of the transparent toner is located between each of the basic-color toner images and the outer circumferential surface 151 in a state after toner images in respective colors are transferred to the outer circumferential surface 151.

In this case, the basic-color toner images do not easily come into contact with the outer circumferential surface 151 directly.

In this case, the basic-color toner images are less likely to remain on the outer circumferential surface 151 when the toner images are transferred from the outer circumferential surface 151 to the sheet P. Then, in this case, efficiency in transfer of the basic-color toner images to the sheet P may be improved.

In the configuration in which the upstream other-color image forming part 202A is not provided and in which only the downstream other-color image forming part 202B is provided, it is difficult to form the layer of the transparent toner at the surface-layer-side portion. In this case, efficiency in transfer of the basic-color toner images is not improved easily.

In the exemplary embodiment, as described above, both the upstream other-color image forming part 202A and the downstream other-color image forming part 202B are provided. The exemplary embodiment is not configured such that only one of the upstream other-color image forming part 202A and the downstream other-color image forming part 202B is provided.

In this case, the aforementioned various types of inconveniences that can occur when only one of the upstream other-color image forming part 202A and the downstream other-color image forming part 202B is provided may be less likely to occur.

That is, an inconvenience in which the basic-color toner images are covered, an inconvenience in which the layer of the white toner does not easily function as a base, and the like are less likely to occur. In addition, an inconvenience in which the layer of the toner having adhesiveness does not easily function as a layer for adhesion, an inconvenience in which efficiency in transfer of the basic-color toner images is not easily improved, and the like are less likely to occur.

Here, among the multiple image forming units 250 provided in the basic-color image forming part 201, the image forming unit 250 located most downstream in the moving direction of the intermediate transfer belt 15 is hereinafter referred to as “most-downstream image forming unit 250K” in the present specification.

In the exemplary embodiment, the image forming unit 250 provided in the black image forming part 200K corresponds to the most-downstream image forming unit 250K.

In addition, among the multiple image forming units 250 provided in the basic-color image forming part 201, the image forming unit 250 located most upstream in the moving direction of the intermediate transfer belt 15 is hereinafter referred to as “most-upstream image forming unit 250J” in the present specification.

In the exemplary embodiment, the image forming unit 250 provided in the yellow image forming part 200Y corresponds to the most-upstream image forming unit 250J.

In the exemplary embodiment, the downstream other-color image forming part 202B enables toner-image formation with a toner in a color other than the basic colors to be performed downstream of the basic-color image forming part 201 without detachment of the most-downstream image forming unit 250K.

Specifically, formation of a toner image with the aforementioned fluorescent toner and a toner image with the functional toner may be enabled to be performed downstream of the basic-color image forming part 201.

In the exemplary embodiment, toner-image formation with a toner in a color other than the basic colors may be enabled to be performed without detachment of the most-downstream image forming unit 250K, which is the image forming unit 250 for black.

Here, it is assumed that, in the configuration, the downstream other-color image forming part 202B is not provided and only the basic-color image forming part 201 and the upstream other-color image forming part 202A are provided.

Even in this configuration, by detaching the most-downstream image forming unit 250K, toner-image formation with a toner in a color other than the basic colors may be enabled to be performed downstream of the basic-color image forming part 201.

Specifically, in this case, the detached most-downstream image forming unit 250K is attached to the upstream other-color image forming part 202A. Further, the image forming unit 250 for forming a toner image in a color other than the basic colors is set in a space created by detaching the most-downstream image forming unit 250K.

Consequently, toner-image formation with a toner in a color other than the basic colors is enabled to be performed downstream of the basic-color image forming part 201.

Incidentally, in this case, repositioning of the most-downstream image forming unit 250K is required, and the workload of an operator increases. That is, detachment of the most-downstream image forming unit 250K and setting of the detached most-downstream image forming unit 250K with respect to the upstream other-color image forming part 202A are required, and the workload of the operator increases.

In contrast, in the exemplary embodiment, the downstream other-color image forming part 202B is provided.

In this case, toner-image formation with a toner in a color other than the basic colors may be enabled to be performed downstream of the basic-color image forming part 201 without detachment of the most-downstream image forming unit 250K.

Similarly, in the exemplary embodiment, the upstream other-color image forming part 202A enables toner-image formation with a toner in a color other than the basic colors to be performed upstream of the basic-color image forming part 201 without detachment of the most-upstream image forming unit 250J.

In the exemplary embodiment, toner-image formation with a toner in a color other than the basic colors may be enabled to be performed upstream of the basic-color image forming part 201 without detachment of the most-upstream image forming unit 250J, which is the image forming unit 250 for yellow.

### Shipping Form of Image Forming Apparatus

Here, as a shipping form of the manufactured image forming apparatus 100, a form in which the image forming apparatus 100 is shipped in a state in which the image forming units 250 are not mounted on the upstream other-color image forming part 202A and the downstream other-color image forming part 202B is conceivable.

In the exemplary embodiment, even in this case, it may be possible for the part where the upstream other-color image forming part 202A is located to function as a fluorescent-toner-image forming part, which is the image forming part 200 that forms an image with a fluorescent toner in one color.

In the exemplary embodiment, by mounting the image forming unit 250, which forms an image with a fluorescent toner, on the upstream other-color image forming part 202A later, the part where the upstream other-color image forming part 202A is located may be enabled to function as a fluorescent-toner-image forming part.

Specifically, for example, the part where the upstream other-color image forming part 202A is located may be enabled to function as a fluorescent-toner-image forming part that forms an image with a fluorescent toner in pink.

In the exemplary embodiment, even in a state in which the image forming unit 250 is not mounted initially, the upstream other-color image forming part 202A may be enabled, as a result of the image forming units 250 being mounted on the upstream other-color image forming part 202A later, to form a fluorescent toner image.

Similarly, even in a form in which the image forming apparatus 100 is shipped in a state in which the image forming unit 250 is not mounted on the downstream other-color image forming part 202B, it may be possible for the part where the downstream other-color image forming part 202B is located to function as a fluorescent-toner-image forming part.

By mounting a unit that forms an image with a fluorescent toner on the image forming apparatus 100 after shipment of the image forming apparatus 100, the part where the downstream other-color image forming part 202B is located may be enabled to function as a fluorescent-toner-image forming part that forms an image with a fluorescent toner.

Specifically, for example, the part where the downstream other-color image forming part 202B is located may be enabled to function as a fluorescent-toner-image forming part that forms an image with a fluorescent toner in green.

### Particle Diameter of Toner

In the exemplary embodiment, the average particle diameter of the aforementioned fluorescent toner used in each of the upstream other-color image forming part 202A and the downstream other-color image forming part 202B is larger than the average particle diameter of the non-fluorescent toner used in the basic-color image forming part 201.

In the exemplary embodiment, the average particle diameter of the fluorescent toner used in each of the other-color image forming parts 202 is larger than the average particle diameter of each of yellow, magenta, cyan, and black non-fluorescent toners.

Specifically, the average particle diameter of the fluorescent toner in pink and the average particle diameter of the fluorescent toner in green are each larger than the average particle diameter of each of yellow, magenta, cyan, and black non-fluorescent toners.

In addition, in the exemplary embodiment, the average particle diameter of the aforementioned fluorescent toner in yellow and the average particle diameter of the fluorescent toner in orange are also each larger than the average particle diameter of each of yellow, magenta, cyan, and black non-fluorescent toners.

In the exemplary embodiment, the average particle diameter of the non-fluorescent toner is 3 to 5 μm. That is, the average particle diameter of the toner in each of the basic colors consisting of the aforementioned four colors is 3 to 5 μm.

In contrast, the average particle diameter of the fluorescent toner is 5 to 8 μm.

Note that the numerical range indicated by using “to” is a range in which the numerical value described before “to” and the numerical value described after “to” are not included as the minimum value and the maximum value, respectively, in the specification.

In the exemplary embodiment, the average particle diameter of the fluorescent toner used in each of the multiple other-color image forming parts 202 is larger than the average particle diameter of the non-fluorescent toner used in the basic-color image forming part 201.

Consequently, both improvement in quality and expansion of the color gamut in an image formed on the sheet P may be easily addressed in the exemplary embodiment.

When a fluorescent toner is also used in addition to a non-fluorescent toner as in the exemplary embodiment, it may be possible to address expansion of the color gamut of a formed image, compared with that when only the non-fluorescent toner is used.

Here, in general, when the particle diameter of toner is reduced, granularity of the toner can be increased, and improvement in the quality of a formed image can be addressed. However, when the particle diameter of a fluorescent toner is also reduced similarly, the color forming performance decreases and makes it difficult to address expansion of the color gamut.

Thus, the exemplary embodiment is configured such that the average particle diameter of the fluorescent toner is larger than the average particle diameter of the non-fluorescent toner. In this case, it may be possible to address expansion of the color gamut while addressing improvement in the quality of a formed image.

In addition, in the exemplary embodiment, the average particle diameter of the fluorescent toner is smaller than the average particle diameter of the aforementioned toner containing metal powder, is smaller than the average particle diameter of the white toner, and is smaller than the average particle diameter of the toner having adhesiveness.

Specifically, the average particle diameter of each of the toner containing metal powder, the white toner, and the toner having adhesiveness is 8 to 13 μm. In contrast, the average particle diameter of the fluorescent toner is 5 to 8 μm.

Note that the average particle diameter of toner means volume average particle diameter. The volume average particle diameter of toner can be measured by using, for example, a laser diffraction-type particle diameter distribution measuring device. In addition, when the shape of toner is an elliptical shape, the average particle diameter of the toner means the average of long diameters of the toner.

### Brightness of Toner

Here, in comparison of the brightness of toner, the brightness of the fluorescent pink toner is lower than the brightness of the fluorescent green toner.

In comparison of brightness between solid images, the brightness of a solid image formed with the fluorescent pink toner is lower than the brightness of a solid image formed with the fluorescent green toner.

In other words, in comparison of images with a halftone dot area ratio of 100%, the brightness of the image formed with the fluorescent pink toner is lower than the brightness of the image formed with the fluorescent green toner.

Therefore, in the exemplary embodiment, the fluorescent pink toner is used in the upstream other-color image forming part 202A, and the fluorescent green toner is used in the downstream other-color image forming part 202B.

In the exemplary embodiment, the brightness of the fluorescent toner used by the upstream other-color image forming part 202A is lower than the brightness of the fluorescent toner used by the downstream other-color image forming part 202B.

In this case, the color gamut of an image formed on the sheet P may be further expanded, compared with that when the brightness of the fluorescent toner used by the upstream other-color image forming part 202A is higher than the brightness of the fluorescent toner used by the downstream other-color image forming part 202B.

When the brightness of the toner used by the upstream other-color image forming part 202A is lower than the brightness of the toner used by the downstream other-color image forming part 202B, the toner with lower brightness tends to be located at the surface-layer-side portion of an image formed on the sheet P.

In the exemplary embodiment, the fluorescent pink toner, which is the toner with lower brightness, tends to be located at the surface-layer-side portion.

In this case, the color gamut of an image formed on the sheet P may be further expanded, compared with that when the fluorescent green toner, which is the toner with higher brightness, is located at the surface-layer-side portion.

Here, it is assumed that the toner used by the downstream other-color image forming part 202B is the fluorescent pink toner, which is the toner with lower brightness.

In this case, a toner image formed with this fluorescent pink toner is located at the sheet-side portion. In this case, incident light incident on this toner image with lower brightness decreases, and color forming of this toner image with lower brightness decreases. In this case, the color gamut of the image is not easily expanded.

In contrast, in the exemplary embodiment, a toner image formed with the fluorescent pink toner, which is the toner with lower brightness, is located at the surface-layer-side portion.

In this case, incident light incident on this toner image increases, and color forming of this toner image with lower brightness may improve. In this case, the color gamut of the image may be easily expanded.

Further, in the exemplary embodiment, the upstream other-color image forming part 202A, which uses the fluorescent pink toner, is located upstream of the basic-color image forming part 201 in the moving direction of the intermediate transfer belt 15. Consequently, in this case, a toner image formed with the fluorescent pink toner is located at the surface-layer-side portion located closer than the basic-color toner image to the surface layer.

In this case, color forming of the toner image formed with the fluorescent pink toner may improve, compared with that when the toner image formed with the fluorescent pink toner is located at the sheet-side portion located closer than the basic-color toner image to the sheet P.

### Color Conversion of Image Data

The image forming apparatus 100 receives image data of color spaces of RGB, CMYK, L*a*b*, or the like output from, for example, an image reading device or a personal computer (PC), which is not illustrated.

The image forming apparatus 100 acquires image data of RGB and the like on which the aforementioned toner images to be transferred onto the intermediate transfer belt 15 are based.

Then, image processing is performed on this image data in the image forming apparatus 100. In the image processing, color conversion is performed using a previously set parameter. Through this color conversion, image formation data, which is image data corresponding to each of the multiple image forming parts 200, is generated. In this case, the image formation data for each color is generated.

Specifically, for example, image formation data for each of the four colors of yellow, magenta, cyan, and black and image formation data for each of other colors other than the four colors are generated.

Then, on the basis of the generated image formation data, output of light in the exposure device 13 provided in each of the image forming parts 200 is controlled.

To generate the image formation data for each color, the CPU 11a illustrated in FIG. 2 as one example of a processor acquires state information, which is information on the state of the upstream other-color image forming part 202A and the state of the downstream other-color image forming part 202B.

Here, generation of the image formation data corresponding to each of the upstream other-color image forming part 202A and the downstream other-color image forming part 202B will be described.

To generate this image formation data, the CPU 11a acquires state information, which is information on the state of the upstream other-color image forming part 202A and the state of the downstream other-color image forming part 202B.

Specifically, the CPU 11a acquires, as the state information, information on the types of the mounted image forming units 250.

Each of the image forming units 250 is provided with a memory in which information on the type of the image forming unit 250 is stored. The CPU 11a acquires information on the type of the image forming unit 250 by acquiring the information read from this memory.

On the basis of the acquired state information, the CPU 11a then sets a parameter to be used for generation of the image formation data. Specifically, a parameter to be used for the aforementioned color conversion is set.

Specifically, the CPU 11a reads and acquires a parameter, which is associated with the state specified by the acquired state information, from the secondary storage unit 91 illustrated in FIG. 2.

In the exemplary embodiment, parameters for respective image forming units 250 are registered in the secondary storage unit 91. The CPU 11a reads and acquires, from the secondary storage unit 91, a parameter associated with the state specified by the acquired state information.

Then, the CPU 11a sets the read and acquired parameter as a parameter to be used for the aforementioned color conversion.

Then, on the basis of this set parameter and the acquired aforementioned image data of RGB or the like, the CPU 11a generates image formation data, which is data to be used by the upstream other-color image forming part 202A and the downstream other-color image forming part 202B to form toner images.

Note that the CPU 11a may also determine, in the parameter setting, whether the set parameter that is a parameter set at that point of time is a parameter suitable for a current state.

Then, in this case, it may be determined not to set a new parameter when the set parameter is a parameter suitable for the current state.

It may be determined to set a parameter when the set parameter is not a parameter suitable for the current state.

In this case, when the set parameter is not suitable for the state specified by the state information, the CPU 11a sets a new parameter that is to be used for generation of image formation data.

In addition, the CPU 11a may also cause a predetermined notification to be given to a user when the set parameter is not suitable for the state specified by the state information.

This notification is given, for example, through the UI 45.

Consequently, the user of the image forming apparatus 100 recognizes that the parameter set at that point of time is a parameter not suitable for the current state.

In this case, the user gives, through the UI 45, an instruction to set a new parameter.

In response to this, the CPU 11a reads and acquires, from the secondary storage unit 91, a parameter associated with the state specified by the acquired state information as described above. The CPU 11a then sets the acquired parameter as a new parameter.

### Other Configuration Example of Intermediate-Transfer Image Forming Apparatus

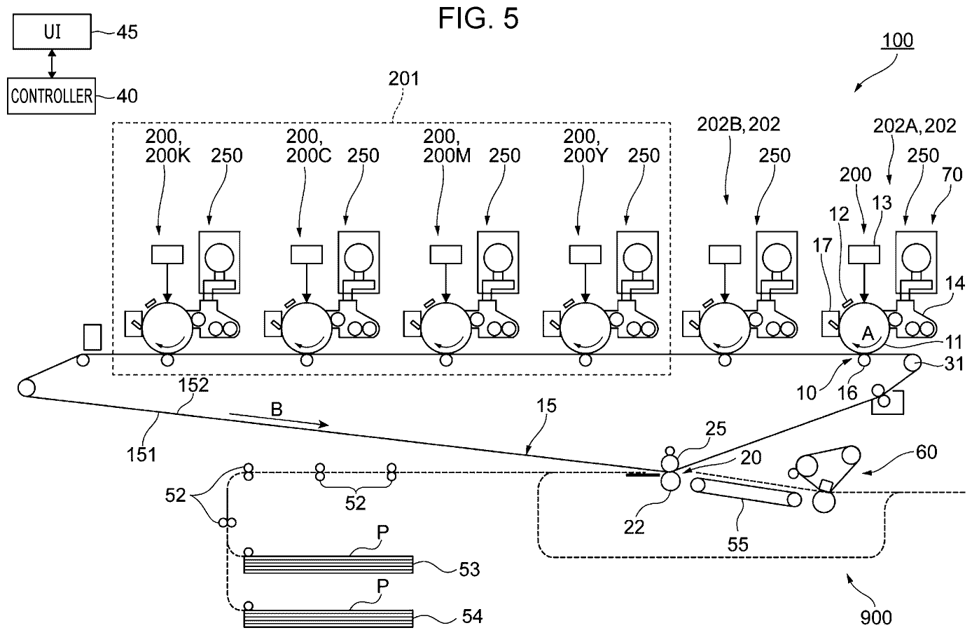

FIG. 5 illustrates another configuration example of the image forming apparatus 100.

In this configuration example, as in the above, the upstream other-color image forming part 202A is provided upstream of the basic-color image forming part 201 in the moving direction of the intermediate transfer belt 15.

In addition, in this configuration example, the downstream other-color image forming part 202B is also provided upstream of the basic-color image forming part 201 in the moving direction of the intermediate transfer belt 15.

The arrangement form of the upstream other-color image forming part 202A, the downstream other-color image forming part 202B, and the basic-color image forming part 201 is not limited to the form illustrated in FIG. 1.

The upstream other-color image forming part 202A and the downstream other-color image forming part 202B may be provided upstream of the basic-color image forming part 201.

The toner used by the upstream other-color image forming part 202A is the fluorescent pink toner also in this configuration example. In addition, the toner used by the downstream other-color image forming part 202B is the fluorescent green toner.

Note that, as in the above, it may be possible also in this configuration example illustrated in FIG. 5 to replace the image forming unit 250 in each of the image forming parts 200.

### Direct-Transfer Image Forming Apparatus

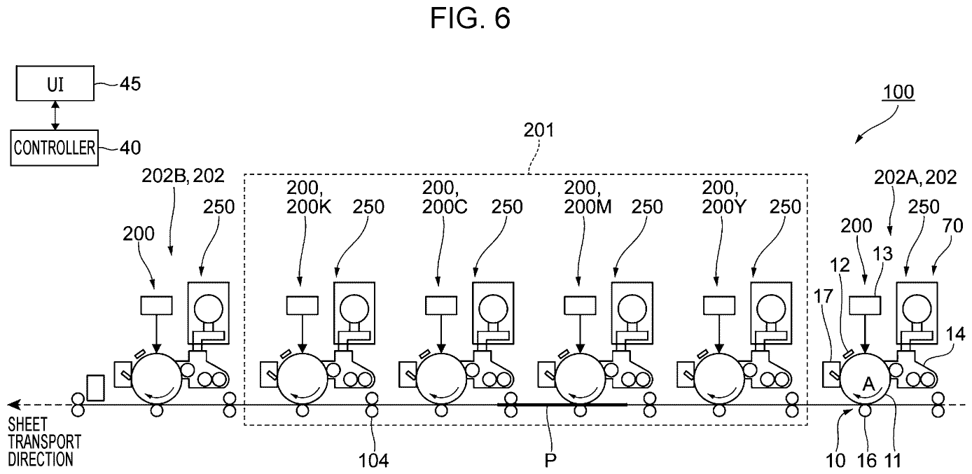

FIG. 6 illustrates the direct-transfer image forming apparatus 100.

In this configuration example, images each formed by a corresponding one of the upstream other-color image forming part 202A, the downstream other-color image forming part 202B, and the basic-color image forming part 201 are transferred directly to the sheet P as one example of a transfer target member.

The sheet P is transported by a transport roller 104, as one example of a transport member, that performs rotational driving.

The upstream other-color image forming part 202A and the downstream other-color image forming part 202B are provided also in this configuration example. In this configuration example, the upstream other-color image forming part 202A is provided upstream of the basic-color image forming part 201. In addition, the downstream other-color image forming part 202B is provided downstream of the basic-color image forming part 201.

In this configuration example, the toner used by the downstream other-color image forming part 202B is the fluorescent pink toner. In addition, the toner used by the upstream other-color image forming part 202A is the fluorescent green toner.

As in the above, the fluorescent pink toner tends to be located at the surface-layer-side portion of an image formed on the sheet P also in the image forming apparatus 100 illustrated in FIG. 6.

Note that, as in the above, it may be possible also in the configuration example illustrated in FIG. 6 to replace the image forming unit 250 in each of the image forming parts 200.

### Other Configuration Example of Direct-Transfer Image Forming Apparatus

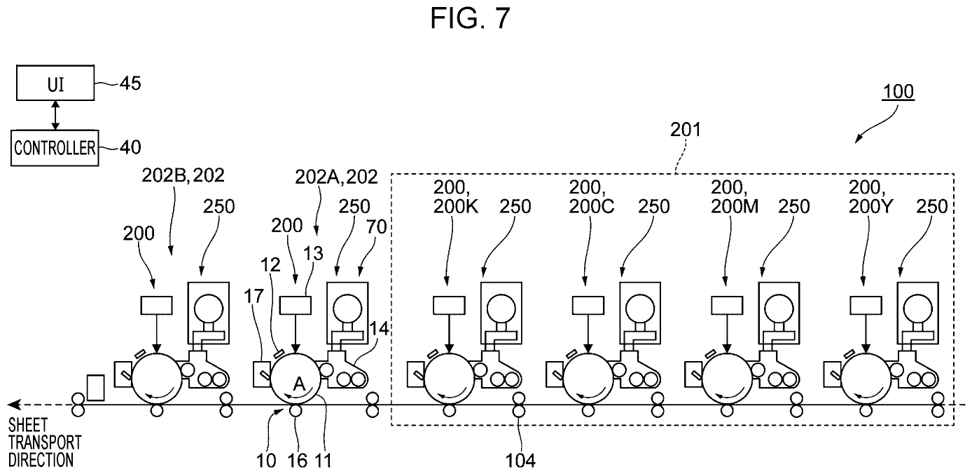

FIG. 7 illustrates another configuration example of the direct-transfer image forming apparatus 100.

Additionally, the configuration illustrated in FIG. 7 may be employed together with the direct transfer system.

In the image forming apparatus 100 illustrated in FIG. 7, the direct transfer system is employed, and the upstream other-color image forming part 202A and the downstream other-color image forming part 202B are located downstream of the basic-color image forming part 201.

Note that the toner used by the downstream other-color image forming part 202B is the fluorescent pink toner also in this configuration example. In addition, the toner used by the upstream other-color image forming part 202A is the fluorescent green toner.

As in the above, an image formed with the fluorescent pink toner tends to be located at the surface-layer-side portion of an image formed on the sheet P also in the image forming apparatus 100 illustrated in FIG. 7.

Also in the image forming apparatus 100 illustrated in FIG. 7, a toner image formed with the fluorescent pink toner tends to be located closer than a toner image formed with the fluorescent green toner to the surface layer of the image.

Note that, as in the above, it may be possible also in this configuration example illustrated in FIG. 7 to replace the image forming unit 250 in each of the image forming parts 200.

In this configuration example illustrated in FIG. 7, the upstream other-color image forming part 202A and the downstream other-color image forming part 202B are provided downstream of the basic-color image forming part 201.

Not limited thereto, the upstream other-color image forming part 202A and the downstream other-color image forming part 202B may be provided upstream of the basic-color image forming part 201.

Note that, also in this case, the toner used by the downstream other-color image forming part 202B may be the fluorescent pink toner, and the toner used by the upstream other-color image forming part 202A may be the fluorescent green toner.

### Use of OGV Toners

While one example in which fluorescent toners are used as toners in other colors has been described above, the toners in other colors are OGV toners in another example. The OGV toners may be used as the toners in other colors.

The OGV toners are, as described above, orange, green, and violet toners. The OGV toners are non-fluorescent toners.

Instead of the aforementioned other-color image forming parts 202 that use the toners in fluorescent pink and fluorescent green, the other-color image forming parts 202 that use the OGV toners may be provided.

That is, the other-color image forming part 202 that uses a non-fluorescent toner in orange, the other-color image forming part 202 that uses a non-fluorescent toner in green, and the other-color image forming part 202 that uses a non-fluorescent toner in violet may be provided.

In this case, three image forming parts 200 are provided in addition to the four image forming parts 200 provided in the basic-color image forming part 201, and seven image forming parts 200 in total are provided.

The use of the OGV toners is common to the aforementioned Hi-Fi color printing. However, the arrangement of the other-color image forming parts 202 are contrived here.

When three other-color image forming parts 202, which are the other-color image forming parts 202 for orange, green, and violet, are provided, the image forming parts 200 may be provided in order of the brightness of the toner used in each of the three image forming parts 200.

Specifically, in the intermediate transfer system illustrated in FIG. 1 and FIG. 5, the other-color image forming parts 202 may be provided in order of orange, green, and violet from the upstream side toward the downstream side in the moving direction of the intermediate transfer belt 15.

In addition, in the direct transfer system illustrated in FIG. 6 and FIG. 7, the other-color image forming parts 202 may be provided in order of orange, green, and violet from the upstream side toward the downstream side in the transport direction of the sheet P.

Note that all of the three other-color image forming parts 202 for green, orange, and violet may be disposed at one of upstream and downstream of the basic-color image forming part 201.

Alternatively, part of the three other-color image forming parts 202 may be provided at one of upstream and downstream of the basic-color image forming part 201 with the other part thereof provided at the other one of upstream and downstream of the basic-color image forming part 201.

Here, the part where the other-color image forming parts 202 for each of violet, orange, and green can be each regarded as a non-fluorescent image forming part, which is the image forming part 200 that forms an image with a non-fluorescent color toner.

The non-fluorescent image forming parts use toners in violet, orange, and green. The non-fluorescent image forming parts each use a toner in a color other than yellow, magenta, cyan, and black.

In the exemplary embodiment, the non-fluorescent image forming parts are constituted by multiple image forming parts 200.

The non-fluorescent image forming parts are constituted by the image forming part 200 that uses the non-fluorescent toner in orange, the image forming part 200 that uses the non-fluorescent toner in green, and the image forming part 200 that uses the non-fluorescent toner in violet.

Alternatively, the image forming apparatus 100 may be provided with the non-fluorescent image forming parts, a fluorescent-pink-image forming part 200, and a fluorescent-green-image forming part 200 in addition to the basic-color image forming part 201.

In this case, the image forming apparatus 100 is provided with the basic-color image forming part 201, the non-fluorescent image forming parts, and the fluorescent image forming parts 200.

More specifically, nine image forming parts 200 are provided in this case.

With this configuration, it may be possible to address expansion of the color gamut of a dark and highly saturated region, compared with that when the color gamut is expanded by only the fluorescent pink image forming part 200 and the fluorescent green image forming part 200.

Note that the image forming parts 200 may be provided in order of the brightness of toner also in this case.

Specifically, the three image forming parts 200 for violet, orange, and green may be provided, as described above, in order of orange, green, and violet or in order of orange, green, and violet.

More specifically, in the intermediate transfer system, the three image forming parts 200 may be provided in order of orange, green, and violet from the upstream side toward the downstream side in the moving direction of the intermediate transfer belt 15.

In addition, in the direct transfer system, the three image forming parts 200 may be provided in order of orange, green, and violet.

In addition, among the nine image forming parts 200, the image forming parts 200 that use the fluorescent pink toner and the fluorescent green toner may be provided in order of fluorescent pink and fluorescent green.

Specifically, in the intermediate transfer system, the image forming parts 200 may be provided in order of fluorescent pink and fluorescent green from the upstream side toward the downstream side in the moving direction of the intermediate transfer belt 15.

In addition, in the direct transfer system, the image forming parts 200 may be provided in order of fluorescent green and fluorescent pink from the upstream side toward the downstream side in the transport direction of the sheet P.

In addition, there may be further included an instruction unit that gives an instruction to a user to use a toner in another color with low brightness in the upstream other-color image forming part 202A.

This instruction unit is constituted by, for example, the CPU 11a and the UI 45.

In the intermediate-transfer image forming apparatus 100, the CPU 11a gives an instruction to a user to use a toner in another color with low brightness in the upstream other-color image forming part 202A.

In the exemplary embodiment, as described above, there is a case where the image forming unit 250 is mounted on the upstream other-color image forming part 202A or the downstream other-color image forming part 202B after shipment of the image forming apparatus 100.

When the aforementioned instruction is given in this case, a likelihood that a toner in another color with low brightness is used in the upstream other-color image forming part 202A increases.

In a specific example, the CPU 11a causes, for example, the UI 45 to display information that “To use the fluorescent toner in pink, please mount the cartridge for pink on the upstream other-color image forming part 202A”.

In this case, an instruction to use a toner in another color with low brightness in the upstream other-color image forming part 202A is given to a user.

Alternatively, the CPU 11a causes, for example, the UI 45 to display information that “To use the fluorescent toner in pink and the fluorescent toner in green, please mount the cartridge for pink on the upstream other-color image forming part 202A and mount the cartridge for green on the downstream other-color image forming part 202B”.

Also in this case, an instruction to use a toner in another color with low brightness in the upstream other-color image forming part 202A is given to a user.

Note that, additionally, an instruction to use a toner in another color with low brightness in the upstream other-color image forming part 202A may be also similarly given to a user when the aforementioned OGV toners are used.

In addition, in the direct-transfer image forming apparatus 100, the CPU 11a gives an instruction to a user to use a toner in another color with low brightness in the downstream other-color image forming part 202B.

Consequently, a likelihood that a toner in another color with low brightness is used in the downstream other-color image forming part 202B increases.

In the direct transfer system, the CPU 11a causes, for example, the UI 45 to display information that “To use the fluorescent toner in pink, please mount the cartridge for pink on the downstream other-color image forming part 202B”.

Alternatively, the CPU 11a causes the UI 45 to display information that, for example, “To use the fluorescent toner in pink and the fluorescent toner in green, please mount the cartridge for pink on the downstream other-color image forming part 202B and mount the cartridge for green on the upstream other-color image forming part 202A”.

In this case, an instruction to use a toner in another color with low brightness in the downstream other-color image forming part 202B is given to a user.

Note that, as in the above, an instruction to use a toner in another color with low brightness in the downstream other-color image forming part 202B may be given to a user also when the aforementioned OGV toners are used.

### Electrostatic Charging of Toner

Here, electrostatic charging of toner will be described.

The intermediate-transfer image forming apparatus 100 illustrated in FIG. 1 and FIG. 5 may be configured such that the charge amount of the toner used in the downstream other-color image forming part 202B is greater than the charge amount of the toner used in the upstream other-color image forming part 202A.

The form in which the toner used in the downstream other-color image forming part 202B is the fluorescent toner in green and the toner used in the upstream other-color image forming part 202A is the fluorescent toner in pink has been described above as one example.

This form may be configured such that the charge amount of the fluorescent toner in green is greater than the charge amount of the fluorescent toner in pink.

When it is configured such that the charge amount of the toner used in the downstream other-color image forming part 202B is greater than the charge amount of the toner used in the upstream other-color image forming part 202A, for example, the characteristics of the carriers are made to be different. Specifically, the characteristics of the carrier used in the upstream other-color image forming part 202A are made to be different from the characteristics of the carrier used in the downstream other-color image forming part 202B.

In each of the upstream other-color image forming part 202A and the downstream other-color image forming part 202B, the toner is electrostatically charged as a result of the carrier and the toner being stirred. In this case, the characteristics of the carrier are made to be different between the upstream other-color image forming part 202A and the downstream other-color image forming part 202B. Consequently, it may be possible to configure such that the charge amount of the toner used in the downstream other-color image forming part 202B is greater than the charge amount of the toner used in the upstream other-color image forming part 202A.

Although not described above, the carrier used in each of the image forming parts 200 is not particularly limited, and a publicly known carrier is used.

The carriers are, for example, a coated carrier in which a surface of a core material made of magnetic powder is coated with resin, a magnetic-powder dispersed carrier in which magnetic powder is dispersed and blended in a matrix resin, a resin-impregnated carrier in which resin is impregnated in porous magnetic powder, and the like. The magnetic-powder dispersed carrier and the resin-impregnated carrier may be a carrier in which constituent particles of the carrier serve as a core material and in which the surface of the core material is coated with resin.

When it is configured such that the charge amount of the toner used in the downstream other-color image forming part 202B is greater than the charge amount of the toner used in the upstream other-color image forming part 202A, the characteristics of the carriers are made to be different.

Specifically, in this case, for example, it is configured such that the electric resistance of the carrier used in the downstream other-color image forming part 202B is greater than the electric resistance of the carrier used in the upstream other-color image forming part 202A.

More specifically, by controlling the types and the amounts of the coating materials with which the carriers are coated, the electric resistance of the carrier used in the downstream other-color image forming part 202B is made to be greater than the electric resistance of the carrier used in the upstream other-color image forming part 202A.

When the charge amount of the toner used in the downstream other-color image forming part 202B is greater than the charge amount of the toner used in the upstream other-color image forming part 202A, it may be possible to address suppression of quality degradation in an image formed on the sheet P.

When the charge amount of the toner used in the downstream other-color image forming part 202B is greater than the charge amount of the toner used in the upstream other-color image forming part 202A, it may be possible to address suppression of quality degradation in an image formed on the sheet P, compared with that when the relationship of the charge amount is opposite.

Here, in each of the image forming parts 200, there is a likelihood of occurrence of an event, commonly known as toner fogging, due to factors such as a situation in which the charge amount of toner is small in toner-image formation. In this case, toner adheres to an unintended portion on which an image is not intended to be formed.

Even when toner fogging occurs, the effect of the toner fogging on an image formed on the sheet P may be small when the image forming part 200 in which the toner fogging has occurred is located upstream in the moving direction of the intermediate transfer belt 15.

When one image forming part 200 in which the toner fogging has occurred is located upstream, the toner adhering to the unintended portion moves, when passing through another image forming part 200 located downstream of the one image forming part 200, to the photoconductor drum 11 provided in the other image forming part 200. Hereinafter, the event in which toner moves to the photoconductor drum 11 is referred to as “reverse movement” in the present specification.

In the exemplary embodiment, due to this reverse movement, the toner adhering to the unintended portion is reduced.

In contrast, a case where the image forming part 200 in which toner fogging has occurred is located downstream in the moving direction of the intermediate transfer belt 15 is considered. In this case, a chance of occurrence of the aforementioned reverse movement decreases, and the toner adhering to an unintended portion is less likely to be reduced.

In this case, quality degradation in an image formed on the sheet P is easily caused.

In consideration of such circumstances, as described above, the charge amount of the toner used in the downstream other-color image forming part 202B is greater than the charge amount of the toner used in the upstream other-color image forming part 202A in the exemplary embodiment.

In this case, it may be possible to suppress occurrence of toner fogging itself in the downstream other-color image forming part 202B.

Note that, although a form in which the charge amount of the toner is increased also in the upstream other-color image forming part 202A is conceivable, there is a likelihood that transfer of toner images from the intermediate transfer belt 15 to the sheet P becomes difficult in this case.

When the charge amount of the toner is increased also in the upstream other-color image forming part 202A, the total charge amount of the toner images formed on the intermediate transfer belt 15 increases. In this case, the total charge amount of the toner images immediately before being transferred to the sheet P increases.

In this case, there is a likelihood that transfer of toner images from the intermediate transfer belt 15 to the sheet P becomes difficult.

In contrast, in the exemplary embodiment, the charge amount of the toner used in the downstream other-color image forming part 202B is greater than the charge amount of the toner used in the upstream other-color image forming part 202A.

In this case, the total charge amount of toner images formed on the intermediate transfer belt 15 decreases, compared with that when the charge amount of the toner used in the upstream other-color image forming part 202A is also great. In this case, quality degradation in an image due to toner fogging may be less likely to occur, and furthermore, toner images may be easily transferred from the intermediate transfer belt 15 to the sheet P.

Note that the direct-transfer image forming apparatus 100 illustrated in FIG. 6 and FIG. 7 also may be configured similarly. That is, it may be configured such that the charge amount of the toner used in the downstream other-color image forming part 202B is greater than the charge amount of the toner used in the upstream other-color image forming part 202A.

In addition, as described above, the non-fluorescent image forming parts that use the OGV toners may be provided instead of the other-color image forming parts 202 for fluorescent colors or in addition to the other-color image forming parts 202 for fluorescent colors.

The aforementioned three image forming parts 200 constituting the non-fluorescent image forming parts may be also similarly configured such that the further the image forming parts 200 are located downstream, the larger the charge amount of the toner.

In addition, there may be further included another instruction unit that gives an instruction to a user to use a toner in which the charge amount is great in the downstream other-color image forming part 202B.

This instruction unit is constituted by, for example, the CPU 11a and the UI 45.

An instruction to use a toner in another color in which the charge amount is great in the downstream other-color image forming part 202B may be given to a user in either of the intermediate transfer system and the direct transfer system.

In the exemplary embodiment, as described above, there is a case where the image forming unit 250 is mounted on the upstream other-color image forming part 202A or the downstream other-color image forming part 202B after shipment of the image forming apparatus 100.

In this case, when an instruction to use a toner in another color in which the charge amount is great in the downstream other-color image forming part 202B has been given to a user, a possibility that a toner in another color in which the charge amount is great is used in the downstream other-color image forming part 202B increases.

Specifically, the CPU 11a causes, for example, the UI 45 to display information that “To use the fluorescent toner in pink and the fluorescent toner in green, please mount the cartridge for pink on the upstream other-color image forming part 202A and mount the cartridge for green on the downstream other-color image forming part 202B”.

In this case, an instruction to use a toner in another color in which the charge amount is great in the downstream other-color image forming part 202B is given to the user substantially.

Alternatively, there may be further included an instruction unit that gives an instruction to a user to use a toner in which the charge amount is small in the upstream other-color image forming part 202A.

The instruction unit is constituted by, for example, the CPU 11a and the UI 45 also in this case.

In this case, the CPU 11a causes the UI 45 to display information that, for example, “To use the fluorescent toner in pink, please mount the cartridge for pink on the upstream other-color image forming part 202A”.

Consequently, an instruction to use a toner in another color in which the charge amount is small in the upstream other-color image forming part 202A is given to a user substantially.

In this case, a state in which a toner in another color in which the charge amount is small is used in the downstream other-color image forming part 202B may be less likely to occur.

In addition, although the image forming apparatus 100 in which toner is used has been described above, the image forming apparatus 100 is not limited to the image forming apparatus 100 in which toner is used.

Other examples of the image forming apparatus 100 are the image forming apparatus 100 in which an inkjet system is used and the image forming apparatus 100 in which an offset printing system is used.

The configurations described above may be applied to the image forming apparatus 100 in which an inkjet system is used or to the image forming apparatus 100 in which the offset printing system is used.

In addition, the aforementioned contrivance relating to toner may be applied to ink for inkjet printing or to ink for offset printing.

In this case, non-fluorescent coloring materials and fluorescent coloring materials used in the image forming apparatus 100 are constituted by ink for inkjet printing or ink for offset printing.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix 1

(((1)))

An image forming apparatus that forms an image on a recording medium, the image forming apparatus comprising:
a yellow-image forming part that forms an image with a non-fluorescent coloring material in yellow;
a magenta-image forming part that forms an image with a non-fluorescent coloring material in magenta;
a cyan-image forming part that forms an image with a non-fluorescent coloring material in cyan;
a black-image forming part that forms an image with a non-fluorescent coloring material in black; and
a fluorescent image forming part that forms an image with a fluorescent coloring material.
(((2)))

The image forming apparatus according to (((1))),
wherein each of the yellow-image forming part, the magenta-image forming part, the cyan-image forming part, and the black-image forming part performs image formation without using a fluorescent coloring material.
(((3)))

The image forming apparatus according to (((1))) or (((2))),
wherein the image forming apparatus is capable of performing image formation on a recording medium without using the fluorescent image forming part, and
wherein an image formed on a recording medium without using the fluorescent image forming part includes no fluorescent coloring material.
(((4)))

The image forming apparatus according to any one of (((1))) to (((3))),
wherein the fluorescent image forming part forms an image with a fluorescent coloring material in a color other than yellow, magenta, cyan, and black.
(((5)))

The image forming apparatus according to (((1))),
wherein the fluorescent image forming part forms an image with at least one fluorescent coloring material among a fluorescent coloring material in pink, a fluorescent coloring material in green, a fluorescent coloring material in yellow, and a fluorescent coloring material in orange.
(((6)))

The image forming apparatus according to any one of (((1))) to (((5))),
wherein each of the yellow-image forming part, the magenta-image forming part, the cyan-image forming part, and the black-image forming part performs image formation in a form that realizes color reproduction in compliance with ISO12647-2, which is an international standard relating to offset printing.
(((7)))

The image forming apparatus according to any one of (((1))) to (((6))),
wherein a plurality of the fluorescent image forming parts are provided.
(((8)))

The image forming apparatus according to (((7))),
wherein one fluorescent image forming part included in the plurality of fluorescent image forming parts forms an image with a fluorescent coloring material in pink, and
wherein another fluorescent image forming part included in the plurality of fluorescent image forming parts forms an image with a fluorescent coloring material in green.
(((9)))

The image forming apparatus according to any one of (((1))) to (((8))),
wherein a non-fluorescent image forming part is further provided, the non-fluorescent image forming part being an image forming part that forms an image with a coloring material in a non-fluorescent color that is a color other than yellow, magenta, cyan, and black.
(((10)))

The image forming apparatus according to (((9))),
wherein the non-fluorescent image forming part is constituted by a plurality of image forming parts, and
wherein, as the plurality of image forming parts constituting the non-fluorescent image forming part, at least an image forming part that forms an image with a non-fluorescent coloring material in orange, an image forming part that forms an image with a non-fluorescent coloring material in green, and an image forming part that forms an image with a non-fluorescent coloring material in violet are provided.
(((11)))

The image forming apparatus according to (((1))),
wherein each of the non-fluorescent coloring materials and the fluorescent coloring material is one of toner, ink for inkjet printing, and ink for offset printing.
(((12)))

An image forming apparatus that forms an image on a recording medium, the image forming apparatus comprising:
a yellow-image forming part that forms an image with a non-fluorescent coloring material in yellow;
a magenta-image forming part that forms an image with a non-fluorescent coloring material in magenta;
a cyan-image forming part that forms an image with a non-fluorescent coloring material in cyan;
a black-image forming part that forms an image with a non-fluorescent coloring material in black; and
an image forming part that is capable of forming an image with a fluorescent coloring material.
(((13)))

The image forming apparatus according to (((12))),
wherein the image forming part that is capable of forming an image with a fluorescent coloring material is capable of performing image formation with a fluorescent coloring material in a color other than yellow, magenta, cyan, and black.
(((14)))

The image forming apparatus according to (((12))),
wherein the image forming part that is capable of forming an image with a fluorescent coloring material is capable of performing image formation with at least one fluorescent coloring material among a fluorescent coloring material in pink, a fluorescent coloring material in green, a fluorescent coloring material in yellow, and a fluorescent coloring material in orange.
(((15)))

The image forming apparatus according to any one of (((12))) to (((14))),
wherein a plurality of fluorescent image forming parts are provided, each of the fluorescent image forming parts being the image forming part that is capable of forming an image with a fluorescent coloring material.
(((16)))

The image forming apparatus according to (((15))),
wherein one fluorescent image forming part included in the plurality of fluorescent image forming parts is capable of performing image formation with a fluorescent coloring material in pink, and
wherein another fluorescent image forming part included in the plurality of fluorescent image forming parts is capable of performing image formation with a fluorescent coloring material in green.

### Appendix 2

(((1)))

An image forming apparatus that forms an image on a recording medium, the image forming apparatus comprising:
a non-fluorescent image forming part that forms an image with a non-fluorescent toner; and
a fluorescent image forming part that forms an image with a fluorescent toner,
wherein an average particle diameter of the fluorescent toner used by the fluorescent image forming part is larger than an average particle diameter of the non-fluorescent toner used by the non-fluorescent image forming part.
(((2)))

The image forming apparatus according to (((1))),
wherein the non-fluorescent image forming part is constituted by a plurality of image forming parts,
wherein the plurality of image forming parts include
   a yellow-image forming part that forms an image with a non-fluorescent toner in yellow,
   a magenta-image forming part that forms an image with a non-fluorescent toner in magenta,
   a cyan-image forming part that forms an image with a non-fluorescent toner in cyan, and
   a black-image forming part that forms an image with a non-fluorescent toner in black, and
wherein an average particle diameter of the fluorescent toner used by the fluorescent image forming part is larger than an average particle diameter of each of yellow, magenta, cyan, and black toners.
(((3)))

The image forming apparatus according to (((2))),
wherein the fluorescent toner is a fluorescent pink toner, and
wherein an average particle diameter of the fluorescent pink toner is larger than an average particle diameter of each of yellow, magenta, cyan, and black toners.
(((4)))

The image forming apparatus according to (((2))),
wherein the fluorescent toner is a fluorescent green toner, and
wherein an average particle diameter of the fluorescent green toner is larger than an average particle diameter of each of yellow, magenta, cyan, and black toners.
(((5)))

The image forming apparatus according to any one of (((1))) to (((4))),
wherein a plurality of the fluorescent image forming parts are provided, and
wherein an average particle diameter of a fluorescent toner used by each of the plurality of fluorescent image forming parts is larger than an average particle diameter of the non-fluorescent toner used by the non-fluorescent image forming part.
(((6)))

The image forming apparatus according to (((5))),
wherein one fluorescent image forming part included in the plurality of fluorescent image forming parts forms an image with a fluorescent pink toner, and
wherein another fluorescent image forming part included in the plurality of fluorescent image forming parts forms an image with a fluorescent green toner.
(((7)))

The image forming apparatus according to any one of (((1))) to (((6))),
wherein the image forming apparatus is also capable of performing image formation with a toner containing metal powder, a white toner, and a toner having adhesiveness, and
wherein an average particle diameter of the fluorescent toner is smaller than an average particle diameter of the toner containing metal powder, is smaller than an average particle diameter of the white toner, and is smaller than an average particle diameter of the toner having adhesiveness.
(((8)))

The image forming apparatus according to any one of (((1))) to (((7))),
wherein an average particle diameter of the non-fluorescent toner is 3 to 5 μm.
(((9)))

The image forming apparatus according to (((8))),
wherein an average particle diameter of the fluorescent toner is 5 to 8 μm.
(((10)))

The image forming apparatus according to (((7))),
wherein an average particle diameter of each of the toner containing metal powder, the white toner, and the toner having adhesiveness is 8 to 13 μm, and
wherein an average particle diameter of the fluorescent toner is 5 to 8 μm.
(((11)))

An image forming apparatus that forms an image on a recording medium, the image forming apparatus comprising:
a non-fluorescent image forming part that forms an image with a non-fluorescent toner; and
an image forming part that is capable of forming an image with a fluorescent toner,
wherein an average particle diameter of the fluorescent toner used by the image forming part that is capable of forming an image with the fluorescent toner is larger than an average particle diameter of the non-fluorescent toner used by the non-fluorescent image forming part.
(((12)))

The image forming apparatus according to (((11))),
wherein a plurality of fluorescent image forming parts are provided, each of the fluorescent image forming parts being the image forming part that is capable of forming an image with the fluorescent toner, and
wherein an average particle diameter of a fluorescent toner used by each of the plurality of fluorescent image forming parts is larger than an average particle diameter of the non-fluorescent toner used by the non-fluorescent image forming part.
(((13)))

The image forming apparatus according to (((12))),
wherein one fluorescent image forming part included in the plurality of fluorescent image forming parts is capable of using a fluorescent pink toner, and
wherein another fluorescent image forming part included in the plurality of fluorescent image forming parts is capable of using a fluorescent green toner.

What is claimed is:

1. An image forming apparatus that forms an image on a recording medium, the image forming apparatus comprising:
a yellow-image forming part that forms an image with a non-fluorescent coloring material in yellow;
a magenta-image forming part that forms an image with a non-fluorescent coloring material in magenta;
a cyan-image forming part that forms an image with a non-fluorescent coloring material in cyan;
a black-image forming part that forms an image with a non-fluorescent coloring material in black; and
a fluorescent image forming part that forms an image with a fluorescent coloring material.

2. The image forming apparatus according to claim 1,
wherein each of the yellow-image forming part, the magenta-image forming part, the cyan-image forming part, and the black-image forming part performs image formation without using a fluorescent coloring material.

3. The image forming apparatus according to claim 1,
wherein the image forming apparatus is capable of performing image formation on a recording medium without using the fluorescent image forming part, and
wherein an image formed on a recording medium without using the fluorescent image forming part includes no fluorescent coloring material.

4. The image forming apparatus according to claim 1,
wherein the fluorescent image forming part forms an image with a fluorescent coloring material in a color other than yellow, magenta, cyan, and black.

5. The image forming apparatus according to claim 1,
wherein the fluorescent image forming part forms an image with at least one fluorescent coloring material among a fluorescent coloring material in pink, a fluorescent coloring material in green, a fluorescent coloring material in yellow, and a fluorescent coloring material in orange.

6. The image forming apparatus according to claim 1,
wherein each of the yellow-image forming part, the magenta-image forming part, the cyan-image forming part, and the black-image forming part performs image formation in a form that realizes color reproduction in compliance with ISO12647-2, which is an international standard relating to offset printing.

7. The image forming apparatus according to claim 1,
wherein a plurality of the fluorescent image forming parts are provided.

8. The image forming apparatus according to claim 7,
wherein one fluorescent image forming part included in the plurality of fluorescent image forming parts forms an image with a fluorescent coloring material in pink, and
wherein another fluorescent image forming part included in the plurality of fluorescent image forming parts forms an image with a fluorescent coloring material in green.

9. The image forming apparatus according to claim 1,
wherein a non-fluorescent image forming part is further provided, the non-fluorescent image forming part being an image forming part that forms an image with a coloring material in a non-fluorescent color that is a color other than yellow, magenta, cyan, and black.

10. The image forming apparatus according to claim 9,
wherein the non-fluorescent image forming part is constituted by a plurality of image forming parts, and
wherein, as the plurality of image forming parts constituting the non-fluorescent image forming part, at least an image forming part that forms an image with a non-fluorescent coloring material in orange, an image forming part that forms an image with a non-fluorescent coloring material in green, and an image forming part that forms an image with a non-fluorescent coloring material in violet are provided.

11. The image forming apparatus according to claim 1,
wherein each of the non-fluorescent coloring materials and the fluorescent coloring material is one of toner, ink for inkjet printing, and ink for offset printing.

12. An image forming apparatus that forms an image on a recording medium, the image forming apparatus comprising:
a non-fluorescent image forming part that forms an image with a non-fluorescent toner; and
a fluorescent image forming part that forms an image with a fluorescent toner,
wherein an average particle diameter of the fluorescent toner used by the fluorescent image forming part is larger than an average particle diameter of the non-fluorescent toner used by the non-fluorescent image forming part.

13. The image forming apparatus according to claim 12,
wherein the fluorescent toner is a fluorescent pink toner, and
wherein an average particle diameter of the fluorescent pink toner is larger than an average particle diameter of each of yellow, magenta, cyan, and black toners.

14. The image forming apparatus according to claim 12,
wherein the fluorescent toner is a fluorescent green toner, and
wherein an average particle diameter of the fluorescent green toner is larger than an average particle diameter of each of yellow, magenta, cyan, and black toners.

15. The image forming apparatus according to claim 12,
wherein a plurality of the fluorescent image forming parts are provided, and
wherein an average particle diameter of a fluorescent toner used by each of the plurality of fluorescent image forming parts is larger than an average particle diameter of the non-fluorescent toner used by the non-fluorescent image forming part.

16. The image forming apparatus according to claim 15,
wherein one fluorescent image forming part included in the plurality of fluorescent image forming parts forms an image with a fluorescent pink toner, and
wherein another fluorescent image forming part included in the plurality of fluorescent image forming parts forms an image with a fluorescent green toner.

17. The image forming apparatus according to claim 12,
wherein the image forming apparatus is also capable of performing image formation with a toner containing metal powder, a white toner, and a toner having adhesiveness, and
wherein an average particle diameter of the fluorescent toner is smaller than an average particle diameter of the toner containing metal powder, is smaller than an average particle diameter of the white toner, and is smaller than an average particle diameter of the toner having adhesiveness.

18. The image forming apparatus according to claim 12,
wherein an average particle diameter of the non-fluorescent toner is 3 to 5 μm.

19. The image forming apparatus according to claim 18,
wherein an average particle diameter of the fluorescent toner is 5 to 8 μm.

20. An image forming apparatus that forms an image on a recording medium, the image forming apparatus comprising:
yellow-image forming means for forming an image with a non-fluorescent coloring material in yellow;
magenta-image forming means for forming an image with a non-fluorescent coloring material in magenta;
cyan-image forming means for forming an image with a non-fluorescent coloring material in cyan;
black-image forming means for forming an image with a non-fluorescent coloring material in black; and
fluorescent image forming means for forming an image with a fluorescent coloring material.
